(19) United States
(12) Patent Application Publication
(10) Pub. No.: US 2010/0299056 A1
(43) Pub. Date: Nov. 25, 2010

(54) METHOD FOR DETERMINING A ROUTE AND DEVICE THEREFOR

(76) Inventors: Guido Mueller, Quedlinburg (DE); Michael Laedke, Hildesheim (DE)

Correspondence Address: KENYON & KENYON LLP, ONE BROADWAY, NEW YORK, NY, 10004, US

(21) Appl. No.: 12/734,939

(22) PCT Filed: Oct. 14, 2008
(86) PCT No.: PCT/EP2008/063752

§ 371 Date: Aug. 17, 2010

(30) Foreign Application Priority Data
Dec. 13, 2007 (DE) 10 2007 060 047.1

(51) Int. Cl. G01C 21/36

(52) U.S. Cl. 701/200

(57) ABSTRACT

A method for determining a route from a starting point to a destination includes optimizing the route with regard to a mixture of two criteria to minimize the energy consumption, a first criterion being the length of the route, and a second criterion represents a number of acceleration operations along the route.

### BACKGROUND OF THE INVENTION

1. Field of the Invention

The present invention relates to a device and a method for optimizing a travel route.

2. Description of Related Art

Modern navigation systems make it possible to determine routes that constitute an optimum with regard to certain criteria, such as the shortest driving time or driving distance. In addition, certain route segments may be excluded from the route determination, e.g., tunnels, toll roads or ferries. Furthermore, by considering digitally coded traffic news transmitted according to ISO 14819 via radio, for example, it is possible to take the instantaneous traffic situation into account, i.e., especially current traffic interruptions, when determining the route.

A fast route using the highway usually entails higher trip mileage in comparison with a short route, so that, despite this lower engine running time, more energy is required in order to manage the longer route at higher speed. Conversely, a similar statement may be made for the short route since despite the fact that less energy is used to move the car at mostly lower speeds, the time for covering the route is longer and the number of acceleration operations is greater as well. Since neither the driving time nor the length of the route directly correlates with the energy consumption, an optimum route with regard to travel time or travel distance will usually not represent the optimum with regard to energy consumption. Current realizations for determining a route that is most advantageous from the aspect of energy consumption pursue the strategy of determining an optimized route with regard to a mixture of the criteria of short route and fast route, it being assumed that this tends to use less fuel than without this criteria mixture.

From published German patent document DE 196 05 458 C1, a vehicle navigation system is known which determines a multitude of alternative routes from a starting point to a destination, and then selects from these alternative routes for navigation the route that features the lowest energy consumption. To determine the fuel consumption of each alternative route, the differences in altitude that must be overcome on these routes are evaluated, a direct correlation being assumed between fuel consumption and altitude differences to be overcome.

Published European patent document EP 1 505 555 B1 describes a further development of the afore-described vehicle navigation system, in which a temporal upper limit for the overall driving time of the selected route is additionally considered when determining the route featuring the lowest fuel consumption, so that a route that features the most advantageous fuel consumption is ultimately determined from among the various possible routes that do not exceed a maximum driving time. Furthermore, relative fuel consumption values for uphill segments and downhill segments are provided, so that an individual absolute fuel consumption for a sub-distance can be determined from a vehicle-specific average consumption value and the topology-dependent relative values.

### BRIEF SUMMARY OF THE INVENTION

The present invention has the advantage that it improves a route determination based on the objective of achieving the lowest possible overall energy consumption. This is realized in a relatively easy manner, without the need to evaluate vehicle-specific parameters. A navigation system designed according to the present invention is thereby able to be used in any kind of vehicle, even changing vehicles, without further adaptation. Furthermore, it is advantageously possible to use information that is available in map data for current (vehicle) navigation systems as it is, so that, for one, there is no need to adapt the map data for this purpose and for another, an associated data volume and thus a storage requirement for the map data does not increase further.

Toward this end, in a method for determining a route from a starting point to a destination, a route that is most advantageous with regard to the energy consumption is determined by optimizing the route with regard to a mixture of two criteria, of which a first criterion is the length of the route, and the second criterion is an overall number of acceleration operations along the route.

This second criterion may advantageously be a road class, it being assumed, for instance, that in contrast to roads within city limits, interstates and highways and the like feature a low number of intersections and other traffic nodes requiring acceleration operations. This criterion may also be a development state of traffic routes, in this case particularly the number of traffic nodes per route. These criteria are available in the usual map data of current navigation systems.

The method according to the present invention may advantageously be implemented in a navigation device for motor vehicles.

### BRIEF DESCRIPTION OF THE DRAWINGS

FIG. 1 shows a block diagram of a vehicle navigation system as an example of a system for implementing the method according to the present invention

FIG. 2 shows a diagram which illustrates the correlations between a route calculation that is optimized with regard to distance, road class and absence of intersections, and optimized with regard to energy consumption.

### DETAILED DESCRIPTION OF THE INVENTION

The actual energy consumption of a vehicle is able to be determined only at considerable expense since it differs depending on the vehicle type and is also dependent on additional external criteria. Characteristics specific to the vehicle type are, for example, the aerodynamic resistance, and external criteria are, for example, head wind or the condition of the road.

Therefore, a method is described in the following text that uses known parameters to approximate the energy consumption for a route, in this case, the energy consumption of a vehicle operated by an internal combustion engine examined here by way of example.

If a route Ri is to be covered, for instance, the required fuel or the energy consumption FC(Ri), hereinafter simply FC, is able to be determined by

a) the fuel component required for the acceleration operations, and
b) the fuel component required for maintaining a speed.

$$FC = {FC}_{{a = 0}_{V = const}} + {FC}_{{a 〉 0}_{V \neq const}}$$

where
FC: fuel consumption
a: acceleration
v: speed

$${FC}_{{a = 0}_{V = const}}$$

is the component for maintaining the speed.
This value depends on and also is a function of the personally desired final speed vₚₑᵣₛ and the travel distance. Therefore,

$${FC}_{{a = 0}_{V = const}} = f ( {v}_{pers} , distance ) .$$

Here, the lower the speed and the shorter the distance, the lower the fuel consumption tends to be.

$${FC}_{{a 〉 0}_{V \neq const}}$$

is the component for the acceleration operations.

This value depends on and therefore is a function of the personally desired final speed vₚₑᵣₛ and the number of acceleration operations. Therefore,

$${FC}_{{a 〉 0}_{V \neq const}} = f ( {v}_{pers} , number of accelerations )$$

The consumption tends to decrease the lower speed vₚₑᵣₛ and the lower the number of acceleration operations becomes.

Furthermore, to simplify matters, it may be assumed that vₚₑᵣₛ exerts the same influence in both components. Thus, vₚₑᵣₛ may be isolated as constant:

FC=Vₚₑᵣₛ*(f(distance)+f(acceleration number))

Moreover, to simplify matters, the specific road class speed, e.g., 80 km/h for interstates, is assumed for vₚₑᵣₛ. It is therefore possible to use the known optimization “short route” for determining the variable component “maintaining the speed”. Certain properties of roads may be utilized to determine the variable component “number of acceleration operations”. Suitable properties are the attributes “roads developed without intersections” and “low road class”, e.g., super highways. Road classes in real map data are subdivided according to road classes 0, 1, . . . 6, for example,

0 being super highways,
1 being federal interstates,
2 being country roads,
etc.

In order to optimize the component “number of acceleration operations”, roads developed without intersections and super highways or federal interstates, i.e., roads having a lower road class of 0 or 1, are preferred. In a further step, urban areas, which are categorized by the attribute “developed areas”, may be considered in the determination.

Nowadays, all of these required data are already provided by attributes in real map data used for navigation systems.

A route that is optimized with regard to energy is therefore able to be determined as approximation by a special mixture of “short route” and an “optimization according to special road classes and roads without intersections”.

Dashed curve 32 in the diagram from FIG. 2 represents the increase in driving distance from left to right, the larger the influence of the optimization criterion of low road category 0 or 1 and free of intersections becomes. Solid curve 31 represents the increase in acceleration operations, which rises from right to left in a non-linear manner with increasing consideration of shorter distances.

The information on the abscissa is scaled to 100% in both directions, i.e., the driving route or the overall distance of the route is at a maximum for all routes considered, which is to say, the component of the travel distance optimization is 0, point 36, when the number of acceleration operations is at its lowest. Conversely, the number of acceleration operations is at a maximum when the optimization focuses exclusively on the shortest route length possible, i.e., at point 34, all the way to the left in the diagram.

Adding the two curves 31 and 32 produces the relative fuel or energy consumption in the form of dash-dot curve 33. For the routes examined, for example, minimum 37 of the fuel consumption for the overall route lies at approximately 40% distance optimization and 60% “road class” optimization 0 or 1, or free of intersections, if possible (value 35). This is the optimum with regard to the fuel consumption in this case. Other analyses have indicated that the optimum comes about at 25% optimized for time, and 75% optimized for distance. However, these numbers are merely exemplary values.

For route-calculation purposes, the road segments illustrated in the map data are thus preferably assigned weights which result from the road class to 60% and the route distance to 40%. The route calculation according to a route-calculation algorithm, such as Ford-Moore or Dijkstra, then is performed on the basis of the weights assigned as described.

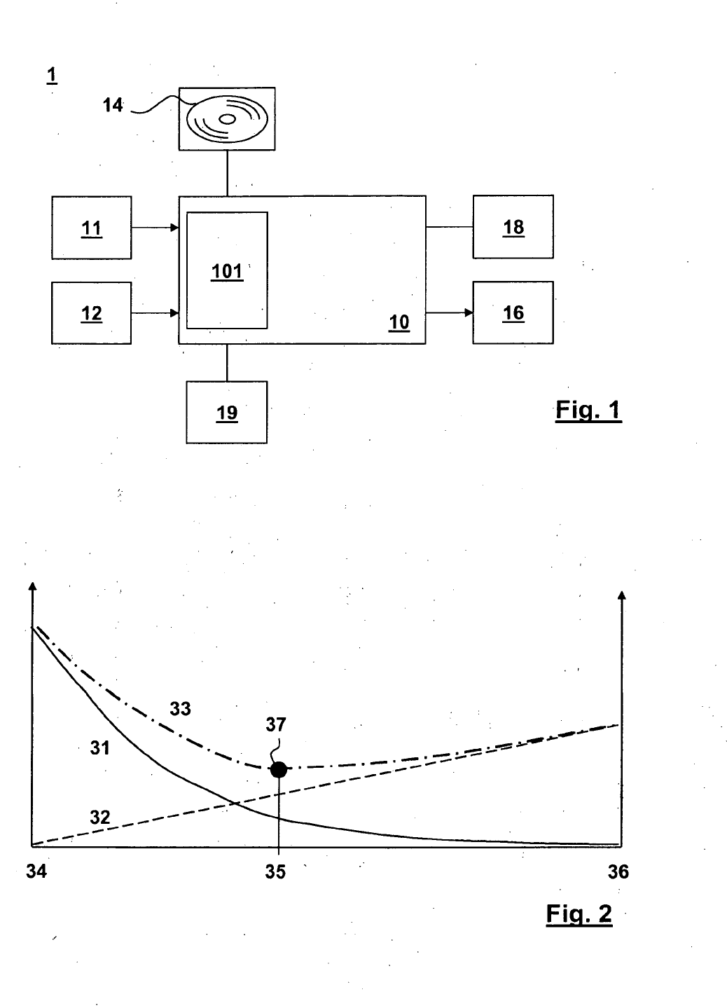

In FIG. 1, reference numeral 1 denotes the system according to the present invention for implementing the method of the present invention, in this case using the example of a navigation system 1 without restricting the general character of the present invention, for permanent or at least temporary use in a motor vehicle, i.e., a vehicle navigation system. However, it is not restricted to on-board navigation.

Especially solutions for route calculators on the Internet are conceivable as well.

Navigation device 1 includes means 11 for self-location and thus for determining a current vehicle location, e.g., a receiver for GPS satellite locating signals, preferably additional inertial sensors or the like, the current location being determined by linking these signals. Via an operating device 12, which preferably includes operating elements, the user can input a destination. Subsequently, a route calculation module 101, which preferably is a software module processed by a computer of a central control 10 of navigation system 1, calculates a route from the current vehicle location to the input destination, via a network of roads which is represented by map data 14 stored in a mass storage device 14.

Map data 14 include elements, i.e., particularly edges, which represent roads of a road network, in the case of a navigation system for road vehicles, road segments. Assigned to these edges are length values which indicate the length of a particular traffic path or traffic path segment. Moreover, as mentioned earlier, road class values are assigned to the edges, and/or attributes describing the degree to which intersection are absent along the road segments, e.g., in the form of “number of traffic nodes per segment length”. These edges are linked to each other via nodes that correspond to real traffic nodes, particularly on- and off-ramps of highways or the like.

Based on these map data, a route from a starting point to a destination, input by the user via operating device 12, is calculated in route calculation module 101 according to a route calculation algorithm known as such, assuming the above basic considerations, so that a route featuring low energy consumption is determined, or in the ideal case, the lowest energy consumption possible. The route calculation is based on edge weights, which have been determined in the manner described above and result from the driving distance to 40%, and the road class to 60% in the case at hand.

The route calculated in this manner is stored in a route memory 18 and used as the basis for a subsequent navigation; in the course of the further movement of the vehicle, the current location of the vehicle is determined and compared to the course of the route; if necessary, navigation information for following the route is generated and acoustically output in the form of synthesized speech, for example, via an output device 16. As an alternative or in addition, the route may also be shown outlined on a map on a display 19, for example.

The weighting factor for the short route criterion and thus also the further criterion of low road class or the criterion of a route free of intersections, if possible, is able to be determined individually for each route calculation, as explained earlier. As an alternative, it is also possible to determine the weighting factor once, and then store it for all subsequent route calculations and reuse it. Furthermore, the weighting factor may also be stored and regularly adapted in automatic fashion as a function of evaluation statistics.

Such evaluation statistics may be prepared outside of the vehicle, by using current map data and conducting reference drives in which the actual energy consumption is determined and compared with the prediction. The new weighting factor is then updated in the navigation system (e.g., by a software update). However, such evaluation statistics may also be prepared online inside the vehicle. This requires the verification of the second criterion within the meaning of the present invention EM in the background, during the drive. To simplify matters, it is assumed that this second criterion is defined only by the number of acceleration operations. To prepare evaluation statistics, the number of acceleration operations must be counted continuously for each relevant road class, scaled accordingly and compared with the standard values, the standard values being corrected, if warranted.

In a further refinement of the present invention, in the event that the system is to determine and display more than one possible route (e.g., rapid, short and fuel-conserving route), it may also be provided that characteristic values for the fuel savings are able to be determined. For instance, the characteristic values are determined from the acceleration operations to be expected per road segment for each route. Relative differences are able to be indicated by comparing the characteristic values for the different routes. For example, a fuel-conserving route may provide 5% in savings compared to a fast route.

1-3. (canceled)

4. A method for determining a travel route for a vehicle from a starting point to a destination using a navigation system, comprising:
optimizing the travel route with regard to a mixture of two criteria to minimize the energy consumption of the vehicle, a first criterion being the length of the travel route, and a second criterion represents a number of acceleration operations along the travel route, wherein the two criteria are assigned predetermined weighting; and
outputting the optimized travel route via an output device.

5. The method as recited in claim 4, wherein the second criterion is one of a traffic road class or the number of traffic nodes included in the travel route.

6. A navigation system for determining a travel route for a vehicle from a starting point to a destination, comprising:
a control unit configured to optimize the travel route with regard to a mixture of two criteria to minimize the energy consumption of the vehicle, a first criterion being the length of the travel route, and a second criterion represents a number of acceleration operations along the travel route, wherein the two criteria are assigned predetermined weighting; and
an output device configured to output the optimized travel route via an output device.
